(19) United States
(12) Patent Application Publication
(10) Pub. No.: US 2009/0183159 A1
(43) Pub. Date: Jul. 16, 2009

(54) MANAGING CONCURRENT TRANSACTIONS USING BLOOM FILTERS

(76) Inventors: Maged M. Michael, Danbury, CT (US); Michael F. Spear, Rochester, NY (US); Christoph von Praun, Munich (DE)

Correspondence Address: F. CHAU & ASSOCIATES, LLC, 130 WOODBURY ROAD, WOODBURY, NY, 11797, US

(21) Appl. No.: 11/973,000

(22) Filed: Jan. 11, 2008

(51) Int. Cl. G06F 9/46

(52) U.S. Cl. 718/101

(57) ABSTRACT

A computer-implemented method for managing concurrent transactions includes recording locations written by a first transaction in a first Bloom filter, recording locations to be read by a second transaction in a second Bloom filter, and performing one of a cancellation or a commission of the second transaction based on an intersection of the first Bloom filter and the second Bloom filter.

### BACKGROUND OF THE INVENTION

1. Technical Field

The present disclosure relates generally to the management of concurrent transactions, and more specifically to methods for managing concurrent transactions using Bloom filters.

2. Discussion of Related Art

Concurrent transactions need to be managed properly to prevent conflicts. An example of a concurrent transaction is two processes simultaneously selling airline tickets from a common pool to different customers. Assume there are only two airline tickets left and two customers respectively request the last two tickets from each of the processes. When the first process reads that the ticket count is 2, it may assume that the last two tickets are available, sell those tickets to the first requesting customer, and write a 0 into the ticket count. However, if the first process fails to update the ticket count before the second process reads the ticket count, the second process may assume that the tickets are still available, and sell the same tickets to the second requesting customer, resulting in a conflict.

Conventional Software Transactional Memory (STM) techniques can prevent such conflicts by attaching metadata to individual shared memory locations. Subsequent runtime instructions read and update this metadata to ensure that an in-progress transaction's reads and writes remain consistent.

In one conventional technique, transactional data is versioned explicitly by associating each location in memory with a packet of metadata encapsulating both version and ownership (e.g., lock) information. However, this technique bears considerable overhead associated with linear atomic operations. For example, metadata modifications are performed using atomic read-modify-write (RMW) operations such as compare-and-swap (CAS)operations and load-linked/store-conditional (LL/SC) operations. However, if a transaction writes to W independent locations, the transaction needs to perform at least W atomic operations and atomic operations are typically substantially slower than regular instructions in current processor designs.

Thus, there is a need for methods for managing concurrent transactions that require fewer atomic instructions.

### SUMMARY OF THE INVENTION

According to an exemplary embodiment of the present invention, a computer-implemented method for managing concurrent transactions includes recording locations written by a first transaction in a first Bloom filter, recording locations to be read by a second transaction in a second Bloom filter, and performing one of a cancellation or a commission of the second transaction based on an intersection of the first Bloom filter and the second Bloom filter.

According to an exemplary embodiment of the present invention, a computer-implemented method for managing concurrent transactions includes maintaining a list for a plurality of committed transactions, maintaining metadata for a plurality of pending transactions, and canceling a pending transaction when at least one bit of an intersection of a first write Bloom filter of a committed transaction and a first read Bloom filter of the pending transaction is set. Each entry in the list includes a first write Bloom filter for storing locations to be written by a corresponding committed transaction. The metadata includes a first read Bloom filter for storing locations to be read by the pending transaction and a second write Bloom filter for storing locations to be written by the pending transaction.

According to an exemplary embodiment of the present invention, a computer-implemented method for managing concurrent transactions includes recording locations written by a first transaction in a first Bloom filter of N bits, recording locations to be read by a second transaction in a second Bloom filter of M bits, determining when N is different from M after the first transaction has logically committed, and when N is different from M, restarting the second transaction, recording locations read by the restarted second transaction in a third Bloom filter of N bits, and performing one of a cancellation or a commission of the second transaction based on an intersection of the first Bloom filter and the third Bloom filter, where N and M are natural numbers (e.g., integers>=1).

According to an exemplary embodiment of the present invention, a computer-implemented method for managing concurrent transactions includes maintaining a plurality of lists of committed transactions, generating a Bloom filter representing locations read by a pending transaction, increasing a priority level of the pending transaction when the pending transaction has aborted based on an intersection of the Bloom filter of the pending transaction and a Bloom filter of the plurality of lists, and restarting the pending transaction when transactions of the lists having a priority level higher than the increased priority level have completed. Each list includes at least one Bloom filter and represents a different priority level. Each Bloom filter in a respective list represents locations written by at least one committed transaction.

### BRIEF DESCRIPTION OF THE DRAWINGS

Exemplary embodiments of the invention can be understood in more detail from the following descriptions taken in conjunction with the accompanying drawings in which:

FIG. 1 illustrates a method for managing concurrent transactions according to an exemplary embodiment of the present invention;

FIG. 2 illustrates a list of recently committed transactions, according to an exemplary embodiment of the present invention;

FIG. 3 illustrates exemplary pseudocode that can be used to implement an exemplary embodiment of the present invention;

FIG. 4 illustrates exemplary pseudocode that can be used to implement an exemplary embodiment of the present invention; and

FIG. 5 illustrates exemplary pseudocode that can be used to implement an exemplary embodiment of the present invention.

### DETAILED DESCRIPTION OF EXEMPLARY EMBODIMENTS

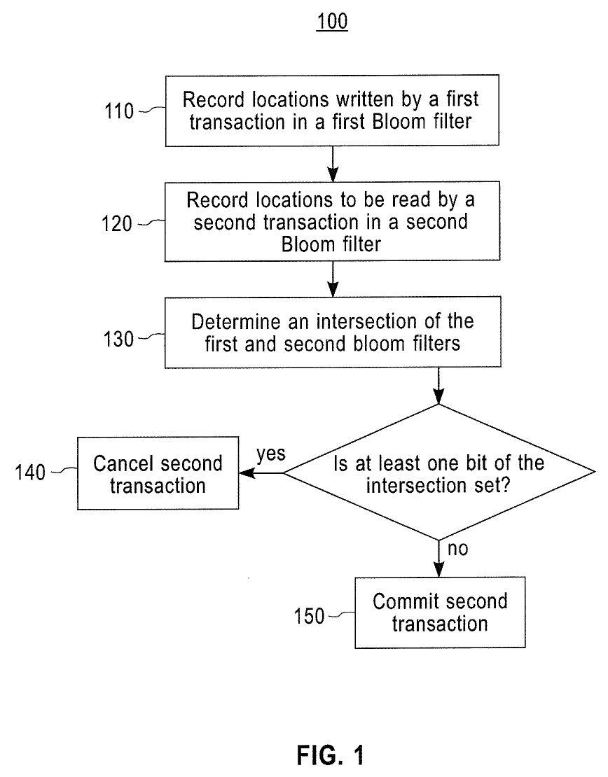

In general, exemplary methods for managing concurrent transactions using Bloom Filters will now be discussed in further detail with reference to illustrative embodiments of FIGS. 1-5.

It is to be understood that the methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

An exemplary embodiment of the present invention includes a method for managing concurrent transactions. Referring to FIG. 1, the method 100 includes the steps of recording locations written by a first transaction in a first Bloom filter (110), recording locations to be read by a second transaction in a second Bloom filter (120), determining an intersection of the first and second Bloom filter (130), and canceling the second transaction when at least one bit of the intersection is set (140) or committing the second transaction when no bits of the intersection are set (150).

A committed transaction is typically in three states. In an first state the committed transaction has not written any values into its locations in shared memory, in a second state the committed transaction has written values into some of its locations in shared memory, and in a third state the committed transaction has successfully written values into all of its locations in shared memory. A committed transaction in the first two states can be said to be in an in-progress state, while a committed transaction in the third state can be said to be in a completed state.

The determination of the intersection of the first and second Bloom filters may be performed during any of the above states. Accordingly, the abortion or commission of the second transaction can be blocked until one of the above states has occurred.

A Bloom filter includes a bit vector of length M and has K corresponding hash functions, where M and K are natural numbers (e.g., integers>=1). In an exemplary embodiment of the present invention it is preferred that K be set to 1 and that M be set to the same value for each Bloom filter.

The locations to be read or written by a particular transaction are stored in a Bloom filter by using the corresponding hash function(s) of the Bloom filter to hash each location to one or more bit positions, and setting the corresponding bit positions in the Bloom filter.

Assume that the first transaction needs to update (e.g., write) locations 0xFF23 and 0xFF67 in shared memory. An empty write Bloom filter is generated, and the locations are hashed using the hash function(s) of the write Bloom filter. Assume that the hash function(s) hashes location 0xFF23 to 1 and location 0xFF67 to 2. Bits 1 and 2 are then set in the write Bloom filter. Next, assume a second transaction needs to read locations 0xFF23 and 0xFF24 after the first transaction had logically committed. An empty Bloom read filter is generated, and these locations are hashed using the same hash function(s). The location 0xFF23 will hash to 1 as before and assume that location 0xFF24 hashes to 3. Bits 1 and 3 are then set in the read Bloom filter. A logical intersection of the bit vectors of the read and write Bloom filters is performed. Since at least one bit of the intersection is set (i.e., bit 1), there is a potential conflict between the first and second transactions. The second transaction can be aborted or restarted to avoid the conflict.

Alternately, assume that the second transaction had only needed to read location 0xFF24 after the first transaction had logically committed. Since no bits of the intersection would then be set, there would likely have been no conflict, and hence no reason to abort or restart the second transaction. An attempt can then be made to commit the second transaction.

The use of Bloom filters may introduce false positives. For example, if the bit vector lengths M of the Bloom filters is small relative to the number of locations that need to be read and/or written, and a prior transaction needs to update several locations in memory, it is more likely to cause an erroneous abortion of a new transaction. For example, assume M=8, and a prior transaction has committed that needs to update 8 locations in memory from 0xF0-0xF7, setting all 8 bits of its wfilter. If a new transaction desires to update location 0xF8, the hash function will hash to a bit in its rfilter that is already set in the prior transaction's wfilter. The intersection of the two filters would indicate a conflict even though location 0xF8 is dissimilar from locations 0xF0-0xF7. Thus, an erroneous abortion of the new transaction would result.

In an exemplary embodiment of the present invention it is preferred that M be several times larger than the number of locations a transaction needs to read and/or write to reduce the rate of false positives. It is desirable that the size of newly generated Bloom filters be dynamically adjustable based on the needs of the application and the resources of the system.

Assume a new transaction has started that requires a larger Bloom filter than all of the previous pending transactions. Locations to be read and/or written by the new transaction can be recorded in the new larger Bloom filter. However, all previous pending transactions that are uncommitted will need to be restarted and their location have to be re-hashed and stored in a new Bloom filter of equivalent size to ensure that future intersection calculations are performed properly.

When there are more than two concurrent transactions, it can be desirable to maintain a global history of committed transactions in a commits list. The commits list may be stored in various data structures such as a linked list, a static array, or a dynamic array.

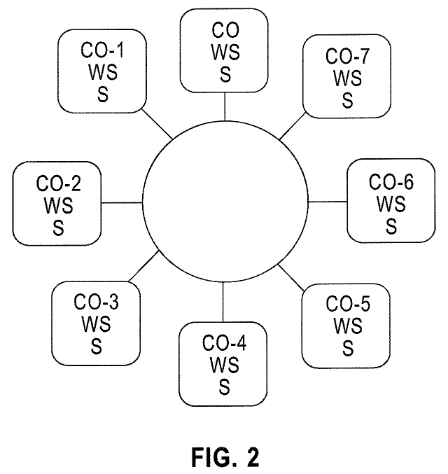

FIG. 2 illustrates a commits list of recently committed transactions, according to an exemplary embodiment of the present invention. Each entry in the commits list represents a committed transaction and includes a write Bloom filter (“wfilter”), a status field, and a commit order number. Entries that have a lower commit order number were committed earlier in time than those with a higher commit order number.

For example, if a pending transaction is committed, an entry is added to the commits list, a wfilter of the entry is set with the locations to be written, and the status field of the entry is set to an in-progress state. When the locations have actually been updated in shared memory, the status field can be set to indicate that it has completed.

Metadata is maintained separately from the commits list for each pending transaction. In an exemplary embodiment of the present invention, the metadata includes two equal-sized read and write Bloom filters (“rfilter” and “wfilter”), respectively representing the locations to be read and written by each pending transaction. The metadata may further include a buffer (“wset”) holding address value/pairs for all speculative writes to those locations and a pointer (“last_v”) into the commits list.

The transactions use buffered updates and only modify shared memory after successfully committing. During execution, a transaction records the locations it reads in a rfilter, records the locations of speculative writes in a wfilter. The transaction may then record the locations of the speculative writes and values to be written in the locations in a wset.

At commit time, a transaction T publishes its wfilter by adding it to the commits list. A concurrent transaction CT can be validated through an O(1) intersection of CT's rfilter with T's wfilter. The intersection may be determined concurrent with T's modifications to shared memory, after which T marks the status field of its wfilter as complete. The validation of a committed write is a constant time operation, merely requiring determination of a Bloom filter intersection.

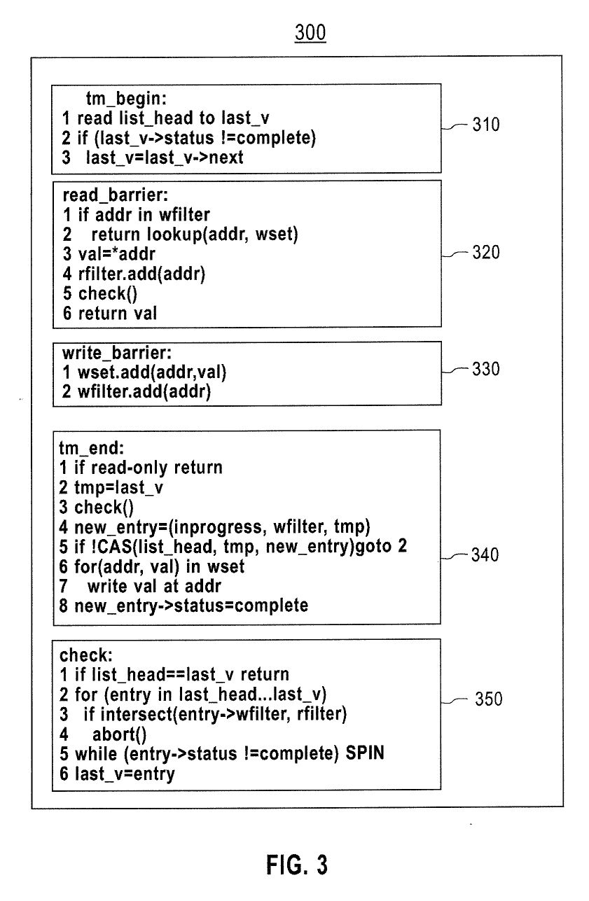

FIG. 3 illustrates exemplary pseudocode 300 that may be used to implement an exemplary embodiment (hereinafter referred to as “Single Writer (SW)”) of the present invention, where only the most recent entry in the commits list may have its status field set to in-progress. The pseudocode 300 includes a tm_begin 310 operation, a read_barrier 320 operation, a write_barrier operation 330, and a check operation 340.

The tm_begin operation 310 occurs during the start of a transaction T. The operation reads the head of the commits list to determine the last clean state of shared memory, represented by the newest entry E in the list for which all entries E′ that are older than E have a status (e.g., completed) indicating that they have no pending writes. The newest entry E may have completed like the older entries or can be in an in-progress state. For example, referring to FIG. 2 and 2A, a new transaction is blocked in tm_begin 310 until the oldest committed transactions (e.g., transactions CO-1-CO-7) have completed and the newest committed transaction (e.g., CO) is at least set to in-progress.

The read_barrier 320 operation is executed to determine if the locations read by the new transaction are likely to conflict with the locations to be written by the committed transaction (e.g., CO). The operation stores the locations read by the pending transaction in a read Bloom filter rfilter and then uses the check operation 350 to check for a conflict between the new transaction and the committed transaction.

When the check 350 operation determines that the committed transaction has completed, the operation returns without any further processing. However, when the committed transaction is still in-progress, the operation performs an intersection of the rfilter of the new transaction and the wfilter of the committed transaction. If at least one bit of the intersection is set, the new transaction can be aborted or restarted. If no bits of the intersection are set, the new transaction blocks until the committed transaction has completed. When the new transaction has writes, it also executes the write_barrier 330 and tm_end 340 operations.

The write_barrier 330 operation generates a buffer wset and updates wset with locations to be written and values to be written in the locations by the new transaction. The operation updates a wfilter of the new transaction using the locations.

The tm_end 340 operation attempts to commit the new transaction that has writes. If the new transaction is successful in committing the new transaction, a new entry representing the new transaction will be added to the commits list. The new entry will include the wfilter generated by the write_barrier 330 operation. A compare and swap operation (CAS) can be used to prevent more than one new transaction from being added to the commits list in an in-progress state. Since the CAS command is atomic, only one of the new transactions will successfully get past the CAS command, while the others will be blocked. A new entry, representative of the new transaction can then be added to the commits list. The locations in shared memory of the successful transaction can then be updated (e.g., a write is performed) and the status of the new entry can then be set to complete.

A SW embodiment prevents concurrent write-back of non-conflicting transactions. However, a SW embodiment can provide that O(T_{w})intersections will be performed by transaction T, where T_{w} is the number of writing locations that are committed during T's execution.

A SW embodiment can exhibit low worst-case overheads. There is only one read-modify-write (RMW) operation in a writing transaction, and the tm_begin operation 310, read_barrier operation 320, and write_barrier operation 330 operation have O(1) implementations. The only non-linear overhead in the tm_end operation 340 is the write-back loop, entailing O(w) unordered writes, and the total cost of the loop in the check operation 350 is O(T_{w}).

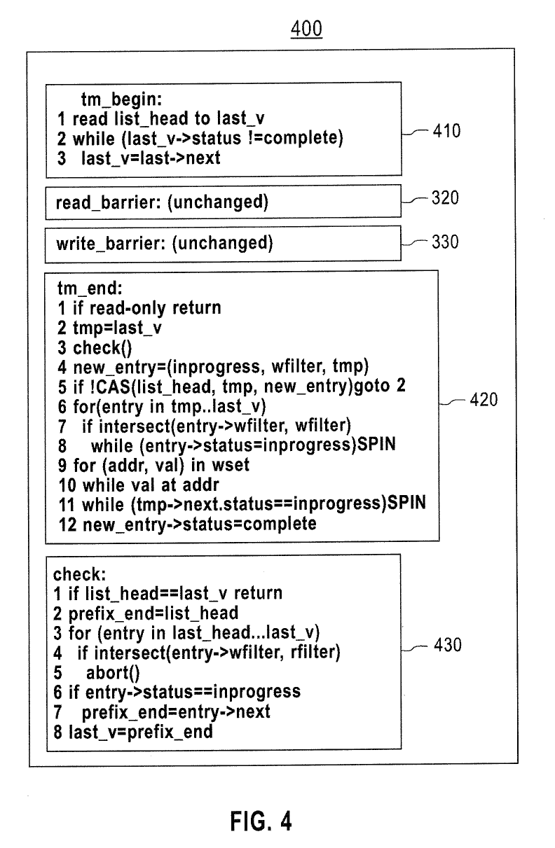

FIG. 4 illustrates exemplary pseudocode 400 that may be used to implement an exemplary embodiment (hereinafter referred to as “Ordered Writer (OW)”) of the present invention, where two or more entries in the commits list may be in the process of writing back to shared memory. The in-progress transactions are grouped together in the commits list such that transactions older than the group have completed. The OW embodiment permits out-of-order write-backs, but requires that the status of newly committed transactions be set in order to a completed status.

The read_barrier operation 320 and write_barrier operation 330 remain unchanged from the pseudocode 300 of FIG. 3.

The check operation 430 operation of FIG. 4 differs from that of FIG. 3 in that a prefix is maintained to keep track of in-progress and completed transactions. Entries that come after the prefix represent transactions that are completed, whereas entries that come before the prefix represent transactions that are in-progress. The prefix can be used to efficiently verify a new transaction against several prior in-progress committed transactions.

The tm_end 420 operation differs from that of FIG. 3 in that it handles the potential conflicts between the additional committed transactions that have in-progress statuses. The operation performs intersections with the wfilter of a new transaction that successfully added itself to the commits lists. When no bits of the intersection are set, the new transaction performs a write-back, but cannot set its status to complete until the prior committed transactions have completed.

An OW embodiment eliminates most of the blocking of the SW embodiment at the cost of increased validation. Eliminating blocking at the tm_begin operation 410 and read_barrier operation 320 introduces the possibility that a wfilter will be tested more than once, raising the validation cost from O(T_{w}) to O(T_{w}×R), where R corresponds to the number of reads.

An OW embodiment can preserve the single RMW property of an SW embodiment. Further, an OW embodiment can decrease the amount of read-read ordering required in a relaxed memory model from R+T_{w}+1 to R+1.

There is an overhead of O(T_{w}) in the tm_end operation 420 operation for a committing writer transaction to ensure write-after-write ordering of transactions. Additionally the prefix introduces an ordering overhead.

However, an OW embodiment is less sensitive to pre-emption than an SW embodiment. While in an SW embodiment, a read-only transaction could block indefinitely for a committed transaction that blocks during write-back, an OW embodiment increases the amount of validation performed by the read-only transaction, but does not obstruct its progress.

Similarly, the delay caused by ordering of transactions should be less in an OW embodiment, since disjoint writes can be performed in parallel, even if the corresponding commits list entries are marked in order.

Further cache interference may be decreased because write filter intersection operations follow the posting of the corresponding filters into the commits list and intersections typically involve thread-private or immutable data.

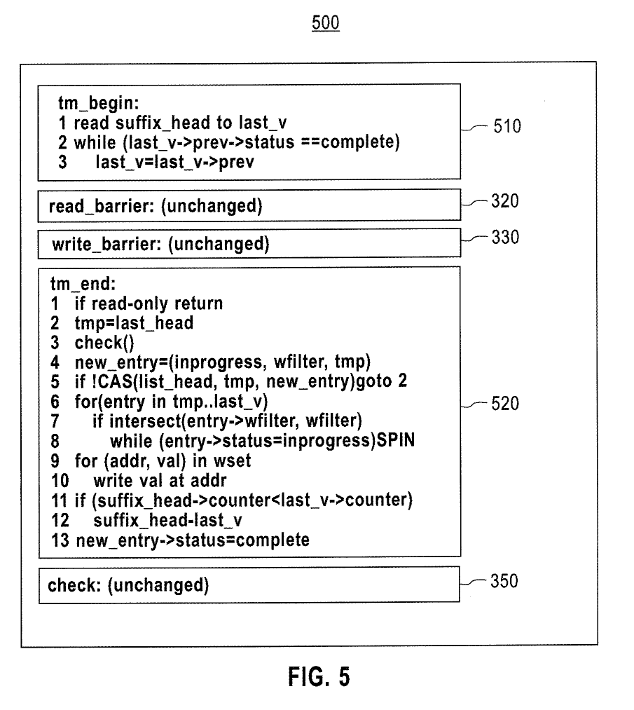

FIG. 5 illustrates exemplary pseudocode 500 that may be used to implement an exemplary embodiment (hereinafter referred to as “Partially Ordered Writer (PW)”) of the present invention, where two or more entries in the commits list may be in the process of writing back to shared memory. The in-progress transactions need not be grouped together in the commits list, as there can be intervening completed transactions. Similar to the OW embodiment, the PW embodiment permits out-of-order write-backs.

The PW embodiment differs from the OW embodiment, in that it maintains a suffix instead of a prefix and the status of new transactions need not be set in order to a completed status.

The tm_begin operation 510 and the tm_end operation 520 maintain the suffix. Entries in the commits list after the suffix represent transactions that have been written back to shared memory. Entries in the commits list before the suffix are either in the process of being written back or have completed their writing back to shared memory. The read barrier operation 320, write barrier operation 330, and check operation 350 are the same as those in FIG. 3. The tm_end operation 520 differs from the tm_end operation 420 of FIG. 4 in that it does not block a new transaction from updating its status to completed until previous transactions have been marked as completed.

It should be noted that the above pseudocode 300, 400, and 500 provided for the SW, OW, and PW embodiments are merely exemplary implementations of the respective embodiments. The present invention is not limited to these particular pseudocode. Further, each of the pseudocode may be implemented using various programming languages.

When memory management is considered in the above embodiments, the commits lists may need to be broken at a distal point to enable reclamation by a garbage collector. In non-garbage collected environments, the same effect can be achieved by breaking the list and then explicitly reclaiming the severed fragment. In the SW and OW embodiments, the sever point can be between the completed and in-progress transactions.

To ensure a firm bound on the total amount of global metadata, the commits list may be implemented using a fixed-size array. This choice necessitates minor delays in the tm_end operations of the OW and POW embodiments, as transactions must wait for previous array entries to be initialized before new committing transactions execute subsequent check instructions. It also requires the presence of a counter field in the SW and OW embodiments. In addition, the OW embodiment needs to ensure that the total number of active transactions is less than the commits list size, and the POW embodiment needs to ensure that transactions do not commit by overwriting a record whose status is incomplete. The POW embodiment avoids the need for a list_head variable, and thus there is no single point of contention in shared memory.

In an exemplary embodiment of the present invention, multiple commits lists are maintained instead of a single one. All of the above embodiments can be modified to make use of the multiple commits lists. Each of the commits lists represent a different priority level. Transactions begin at a low priority, and upon repeated aborts, request permission to increase their priority. When a transaction receives permission to raise its priority, the lower priority commits list(s) is/are locked preventing conflicts with lower priority transaction(s).

Locking lower priority commits lists prevents priority inversion while still allowing reader transactions of all priorities to complete. These reader transactions need to validate against any incomplete writer transactions in the lower priority commits lists, as well as against all new entries in higher priority commits lists. Blocked lower priority transactions can request that their priority increase, in the event that their priority changes. For convenience, multiple commit lists can be merged, with a single value specifying the priority level necessary for writer transactions to execute their RMW operation in the tm_end operation.

It is to be understood that the particular exemplary embodiments disclosed above are illustrative only, as the invention may be modified and practiced in different but equivalent manners apparent to those skilled in the art having the benefit of the teachings herein. Furthermore, no limitations are intended to the herein described exemplary embodiments, other than as described in the claims below. It is therefore evident that the particular exemplary embodiments disclosed herein may be altered or modified and all such variations are considered within the scope and spirit of the invention. Accordingly, the protection sought herein is as set forth in the claims below.

What is claimed is:

1. A computer-implemented method for managing concurrent transactions, the method comprising:
recording locations written by a first transaction in a first Bloom filter;
recording locations to be read by a second transaction in a second Bloom filter; and
performing one of a cancellation or a commission of the second transaction based on an intersection of the first Bloom filter and the second Bloom filter.

2. The computer-implemented method of claim 1, wherein the performing comprises:
canceling the second transaction when at least one bit of the intersection is set; and
committing the second transaction when no bits of the intersection are set.

3. The computer-implemented method of claim 1, wherein the determination of the intersection takes place after the first transaction has committed.

4. The computer-implemented method of claim 3, wherein the determination of the intersection takes place before the first transaction has written values to all of its locations in shared memory.

5. The computer-implemented method of claim 1, wherein each Bloom filter has an equal number of bits.

6. The computer-implemented method of claim 1, wherein each Bloom filter has the same K hash functions, K being a natural number.

7. A computer-implemented method for managing concurrent transactions, the method comprising:
maintaining a list for a plurality of committed transactions, each entry in the list comprising a first write Bloom filter for storing locations to be written by a corresponding committed transaction;
maintaining metadata for a plurality of pending transactions, the metadata comprising a first read Bloom filter for storing locations to read by a pending transaction and a second write Bloom filter for storing locations to be written by the pending transaction; and
canceling the pending transaction when at least one bit of an intersection of a first write Bloom filter and the first read Bloom filter is set.

8. The computer-implemented method of claim 7, further comprising committing the pending transaction when no bits of the intersection are set.

9. The computer-implemented method of claim 8, further comprising adding an entry to the list comprising the second write Bloom filter when the pending transaction is committed.

10. The computer-implemented method of claim 8, wherein each entry in the list further comprises a status field that indicates whether the committed pending transaction has finished writing its locations to shared memory.

11. The computer-implemented method of claim 10, wherein the committed pending transaction is blocked from updating its status field until all other transactions in the list have written their locations to memory.

12. The computer-implemented method of claim 7, wherein each Bloom filter has a same number of bits and a single hash function.

13. A computer-implemented method for managing concurrent transactions, the method comprising:
recording locations written by a first transaction in a first Bloom filter of N bits, N being a natural number;
recording locations to be read by a second transaction in a second Bloom filter of M bits, M being a natural number; and
determining whether N is different from M after the first transaction has logically committed and when N is different from M,
restarting the second transaction;
recording locations read by the restarted second transaction in a third Bloom filter of N bits; and
performing one of a cancellation or a commission of the second transaction based on an intersection of the first Bloom filter and the third Bloom filter.

14. The computer-implemented method of claim 13 wherein the performing comprises:
canceling the second transaction when at least one bit of the intersection is set; and
committing the second transaction when no bits of the intersection are set.

15. The computer-implemented method of claim 13, wherein M is not different from N, the method further comprises performing one of a cancellation or a commission of the second transaction based on an intersection of the first Bloom filter and the second Bloom filter.

16. The computer-implemented method of claim 13, wherein each Bloom filter has the same K hash functions, K being a natural number.

17. A computer-implemented method for managing concurrent transactions, the method comprising:
maintaining a plurality of lists of committed transactions, each list comprising at least one Bloom filter, each list representing a different priority level, each Bloom filter in a respective list representing locations written by at least one committed transaction;
generating a Bloom filter representing locations read by a pending transaction;
increasing a priority level of the pending transaction when the pending transaction has aborted based on an intersection of the Bloom filter of the pending transaction and a Bloom filter of the plurality of lists; and
restarting the pending transaction when transactions of the lists having a priority level higher than the increased priority level have completed.

18. The computer-implement method of claim 17, wherein the lists having a priority level lower than the pending transaction are locked so that new entries cannot be added.

19. The computer-implemented method of claim 17, wherein each Bloom filter has an equal number of bits.

20. The computer-implemented method of claim 17, wherein each Bloom filter has the same K hash functions, K being a natural number.
